(19) United States
(12) Patent Application Publication
(10) Pub. No.: US 2003/0110651 A1
(43) Pub. Date: Jun. 19, 2003

(54) Magnetic compass having illuminatingn device

(76) Inventor: Gin-Sung Chang, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 10/013,699

(22) Filed: Dec. 13, 2001

(51) Int. Cl. G01C 17/24

(52) U.S. Cl. 33/355 R; 33/348

(57) ABSTRACT

The present invention is to provide a magnetic compass, which comprises a base, a compass assembly mounted on the base, a lid pivoted to one end of the base, and an aiming device pivoted to the other end of the base. The aiming device is provided with a magnifying glass, a lighting member and a battery set. The light of the lighting member is projected towards the compass assembly and the battery set supplies electrical current to the lighting member.

### FIELD OF THE INVENTION

The present invention relates generally to a magnetic compass, and more particularly to the magnetic compass having an illuminating device therein so as to enhance the utilization of the magnetic compass in dark.

### BACKGROUND OF THE INVENTION

The conventional magnetic compass, such as the disclosure in U.S. Pat. No. 6,145,209, comprises an aiming plate having a magnifying glass and sighting notch. The sighting notch is adapted to match a sighting slit vertically disposed in a lid so as to form a visual aiming line towards an object by the user. After sighting, the user looks through the magnifying glass to read the direction in degrees on the compass rose.

U.S. Pat. No. 6,145,209 further discloses an illuminating device comprising a mounting plate, a lighting device having a battery, a lighting member (light emitting diode) and a switching device, and a cover plate. The lighting device of the illuminating device is disposed between the transparent bottom of the compass case having a compass rose and a compass needle therein, and the mounting plate. The mounting plate provides a chamber to receive the lighting device, and the cover plate is closed over the bottom section of the mounting plate. The lighting member projects light to the compass rose of the compass case through the transparent bottom of the compass case, thereby illuminating the graduations of the compass rose and allowing the user to read the compass rose in dark.

However, the drawbacks of the above described magnetic compass are:

1. There are an excessive number of structural components that result in difficult assembly as well as higher production cost and malfunction rates.

2. Since the space between the receiving chamber of the mounting plate and the bottom of the compass case is meager, the projection distance of the lighting member is insufficient and, as a result, when light is projected onto the compass rose, only a limited portion is illuminated by a small bright spot of light and the lighting efficiency of the light member is not optimal.

3. Since the lighting member is disposed under the compass rose, its light is only projected onto a fixed area of the compass rose and, as such, does not facilitate the reading of directional degree on the compass rose by the user.

### SUMMARY OF THE INVENTION

The primary object of the present invention is to provide a magnetic compass having an illuminating device, which enhances the utility of the compass in dark.

Another object of the present invention is to provide a magnetic compass having an illuminating device that has fewer structural components as well as a lower production cost and malfunction rate.

To achieve the above objects, the magnetic compass of the present invention comprises a base, a compass assembly mounted on the base, a lid pivoted to one end of the base, and an aiming device pivoted to the other end of the base. The aiming device is provided with a magnifying glass, a lighting member and a battery set. The light of the lighting member is projected towards the compass assembly and the battery set supplies electrical current to the lighting member.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is a top view of the preferred embodiment of the present invention.

FIG. 4 is a sectional view taken along a line 4-4 as shown in FIG. 3.

FIG. 5 is a sectional view of the preferred embodiment of the present invention illustrating the lid in an upright position.

FIG. 6 is a sectional view of the preferred embodiment of the present invention illustrating the aiming device in an upright position.

FIG. 7 is a sectional view of the preferred embodiment of the present invention illustrating the aiming device in operating.

### DETAILED DESCRIPTION OF THE INVENTION

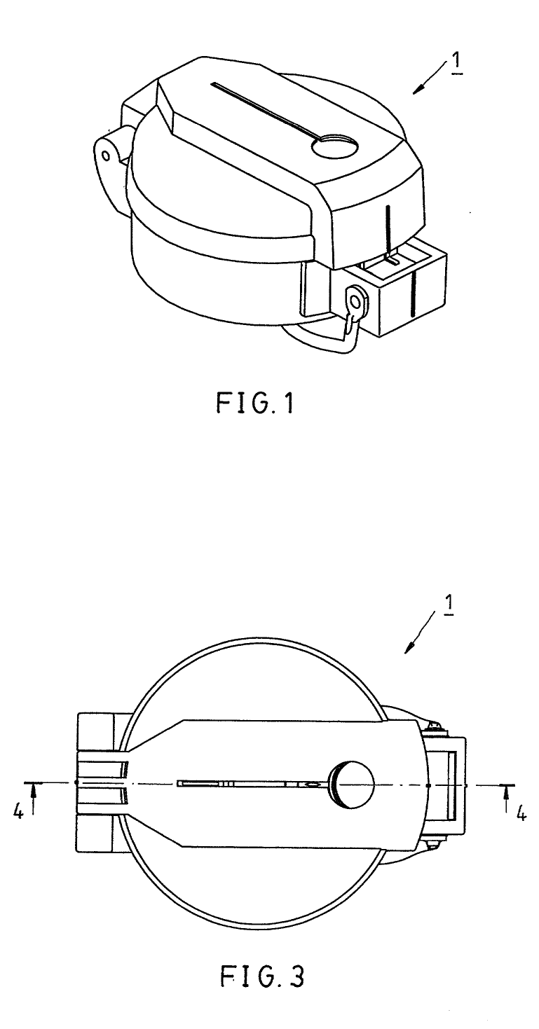

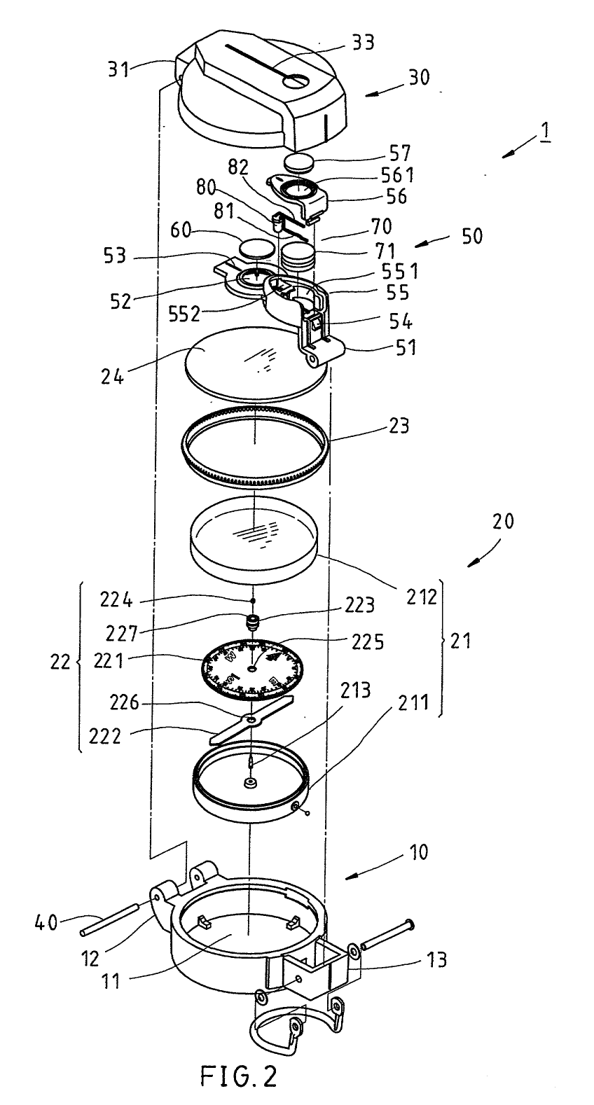

Referring to FIGS. 1-4, the magnetic compass 1 of the preferred embodiment of present invention comprises a base 10, a compass assembly 20, a top lid 30, an aiming device 50, a battery set 70 and a lighting member 80.

The base 10 is provided in the interior thereof with a recessed space 11. The base 10 has a first end and a second end, which are provided with a first hinge mount 12 and a second hinge mount 13 respectively.

The compass assembly 20 is comprised of a case 21, a graduation assembly 22, a decorative ring 23, and a transparent flat lens 24. The case 21 is formed of a cylindrical substructure 211 and a circular transparent cover 212 that are conjoined together and, furthermore, the substructure has a supporting bar 213 embedded at its center. The graduation assembly 22 is formed of a compass rose 221, a magnetized needle 222, a bearing mount 223 and a bearing 224. Directions and degrees are printed along the outer edge of the compass rose 221 and, furthermore, a seating hole 225 is formed at the center of the compass rose 221. The needle 222 is provided at the central portion thereof with an insertion hole 226, furthermore, the needle 222 is attached to the bottom surface of the compass rose 221 such that its insertion hole 226 and the seating hole 225 of the compass rose 221 are aligned along the same axis. The bearing mount 223 is fitted into the seating hole 225 and the insertion hole 226 to conjoin them to the compass rose 221. The bearing mount 223 is provided with a through hole 227 for receiving the bearing 224.

The graduation assembly 22 is situated inside the case 21 such that the supporting bar 213 is inserted into the through hole 227 at the lower extent of the bearing mount 223 and fixed against the bearing 224, enabling the compass rose 221 to freely rotate in place due to the stationary positioning of the supporting rod 213 and since the function of the magnetized needle 222 is based on the magnetic field of the earth, the compass rose 221 is capable of constantly indicating direction relative to the earth. In addition, the case 21 is filled with a liquid so that the compass rose 221 does not readily oscillate. The decorative ring 23 is conjoined to top edge along the lateral periphery of the case 21 and the transparent flat lens 24 is attached onto the decorative ring 23.

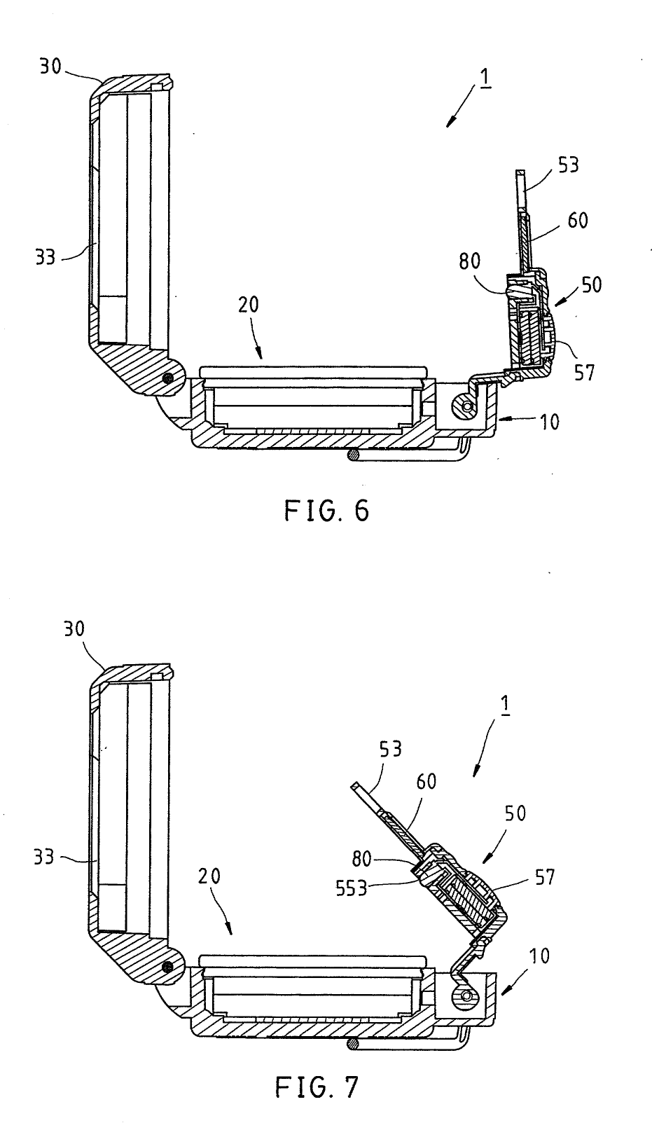

The top lid 30 in the form of a round hood that has a hinge end 31 and, furthermore, the hinge end 31 is movably conjoined to the first hinge mount 12 of the base 10 by means of a pivot shaft 40, enabling the top lid 30 on the base 10 to be folded down to cover the top surface of the base 10 (referring to FIG. 5) or folded up to uncover the top surface of the base 20 (referring to FIG. 6). The top lid 30 has a positioning groove 32 formed in its inner wall that is situated opposite from the hinge end 31 and, furthermore, a sighting slot 33 is vertically disposed along the center of the top lid 30.

The aiming device 50 comprises a mounting seat 55 having a hinge end 51, a bottom portion and a top portion. The hinge end 51 is detachably pivoted to the second hinge mount 13 of the base 10 such that it can be pivoted to a first position and a second position on the base 10, of which the first position means the bottom portion of the mounting seat 55 lying flush against the top section of the base 10 (referring to FIG. 5) and the second position means the aiming device 50 at a 90-degree angle to the base 10 (referring to FIG. 6). In addition, the mounting seat 55 of the aiming device 50 is further provided with a round through hole 52 for fastening a magnifying glass 60 therein, a sighting notch 53 and a latch hook 54 to be engaged with the positioning groove 32 of the top lid 30.

The innovative features of the invention herein includes:

The mounting seat 55 is further provided with a battery compartment 551, an illumination component chamber 552, and an opening disposed at the top portion of the mounting seat and communicated with the battery compartment 551 and illumination component chamber 552. The mounting seat 55 is further provided with a passageway 553 located at the bottom section of the illumination component chamber 552. The aiming device 50 is further provided with a mounting cap 56 covered onto the opening of the mounting seat. The mounting cap 56 has a push button hole 561 for receiving a push button 57 therein.

The battery set 70 consists of two flat cylindrical lithium batteries 71 which are stacked one by one into the battery compartment 551 of the mounting seat 55.

According to this preferred embodiment, the lighting member 80 is an LED installed into the illumination component chamber 552 of the mounting seat 55 such that its light projects towards the passageway 553. The negative terminal 81 of the LED is connected to the negative pole of the battery set 70 and the positive terminal 82 is located at an area between the positive pole of the battery set 70 and the bottom of the push button 57 such that pressing the push button 57 initiates electrical continuity between the battery set 70 and the lighting member 80, thereby enabling the battery set 70 to supply electrical current to the lighting member 80 and causing the lighting member 80 to emit light.

The preceding description of the most preferred embodiment of the magnetic compass 1 of the invention herein introduced its structural components and structural arrangement, and the utilization of the magnetic compass 1 is presented below:

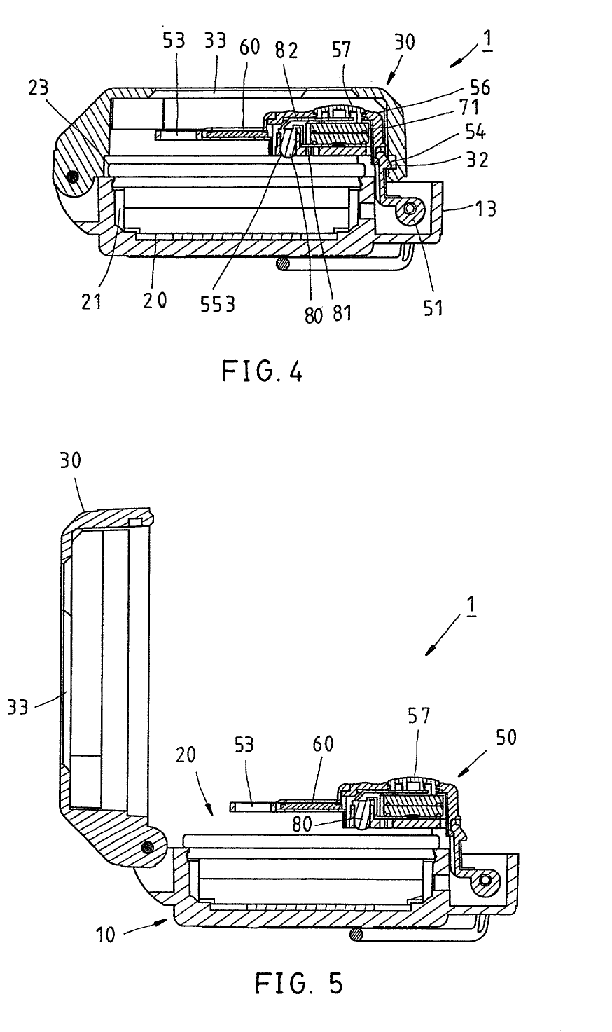

First, when the magnetic compass 1 is not being utilized, as shown by the illustration of the closed state in FIG. 4, the aiming device 50 is located at the first position, wherein the bottom portion of the aiming device 50 lies flush against the top section of the base 10, following which the top lid 30 is folded down to cover the top section of the base 10 and, furthermore, its positioning groove 32 becomes engaged on the latch hook 54 of the aiming device 50, thereby concealing the top portion of the base 1 and the aiming device 50 such that the entire magnetic compass 1 is in a fully closed state.

For utilization, the top lid 30 is first folded up to uncover the top surface of the base 10 such that it is postured at 90-degree angle to the base 10 (as shown in FIG. 5) and then the aiming device 50 is pivoted away from the top surface of the base 10 until it is at an appropriate included angle relative to the base 10 (as shown in FIG. 7). The aiming device 50 is brought near one eye of the user, with the sighting notch 53 positioned directly in front of the eye; the vision of the eye is directed through the sighting notch 53 and sighting slot 33 of the top lid 30 in line with a targeted object, following which the eye looks through the magnifying glass 60 at the lower extent of the aiming device 50 to see the directional graduation on the compass rose 221 of the graduation assembly 22, where the reading viewed on the compass rose 221 indicates the direction in degrees of the targeted object to the user. Since the remaining methods of utilization are identical to that of conventional magnetic compasses, they shall not be further elaborated.

In addition to the methods of utilization, a unique feature of the magnetic compass 1 is its capability to be used at night or under low light conditions, wherein after the user completes the sighting of the targeted object and wants to read the graduations on the compass rose 221, the push button 57 on the aiming device 50 is manually depressed to switch on the lighting member 80, at which time the light rays of the lighting member 80 shines through the passageway 553 in the bottom portion of the aiming device 50 and is projected onto the compass rose 221 to facilitate the user's reading of the direction in degrees indicated on the compass rose 221. The advantages of such illumination includes the following:

1. Since the lighting member 80 is situated on the aiming device 50, adjusting the included angle of the aiming device 50 relative to the base 10 also varies the distance between the lighting member 80 and the compass rose 221. Therefore, the lighting member 80 has a longer light beam projection distance and its scope of illumination is broader and since the lighting efficiency is thereby more optimal, this facilitates the user in reading the direction in degrees indicated on the compass rose 221.

2. Since the lighting member 80 is situated on the aiming device 50, adjusting the included angle of the aiming device 50 relative to the base 10 also varies the position where the lighting member 80 shines on the compass rose 221, lighting efficiency is further optimized.

Additionally, the magnetic compass 1 has fewer structural components as well as a simpler structure and, therefore, its production cost is lower and, furthermore, its malfunction rate is less.

In summation of the foregoing section, since the invention herein is innovative in that the lighting member 80 is located in the aiming device 50 of the magnetic compass 1, lighting efficiency is optimized and, furthermore, its overall structural components, production costs, and malfunction rate are reduced, the invention herein is capable of enhanced functionality.

What is claimed is:

1. A magnetic compass comprising:
a base having a first end and a second end;
a compass assembly mounted on said base;
a top lid pivoted to the first end of the base;
an aiming device pivoted to the second end of the base, said aiming device having a through hole and a magnifying glass fastened in said through hole; wherein
the aiming device is further provided with a lighting member and a battery set; the light of the lighting member is projected towards said compass assembly and the battery set supplies electrical current to said lighting member.

2. The magnetic compass as defined in claim 1, wherein said aiming device is provided with a mounting seat having a battery compartment and an illumination component chamber for receiving said battery set and said lighting member respectively.

3. The magnetic compass as defined in claim 2, wherein the mounting seat of said aiming device is provided with an opening communicated with said battery compartment and said illumination component chamber; the aiming device is further provided with a mounting cap covered onto said opening of said mounting seat.

4. The magnetic compass as defined in claim 3, wherein said opening of the mounting seat is disposed at the top of the mounting seat and communicated with the top portions of said battery compartment and said illumination component chamber respectively.

5. The magnetic compass as defined in claim 2, wherein said illumination component chamber of said mounting seat is provided at the bottom thereof with a passageway, and said lighting member projects light towards said passageway.

6. The magnetic compass as defined in claim 2, wherein said battery set is comprised of two flat cylindrical lithium batteries which are stacked one by one into said battery compartment of said mounting seat.

7. The magnetic compass as defined in claim 2, wherein said lighting member is a light-emitting diode.

8. The magnetic compass as defined in claim 5, wherein said lighting member is a light-emitting diode.

9. The magnetic compass as defined in claim 3, wherein said mounting cap is provided with a push button hole adapted to receive a push button therein;
said battery set is comprised of two flat cylindrical lithium batteries which are stacked one by one into said battery compartment of said mounting seat;
said lighting member is a light-emitting diode which negative terminal is connected to the negative pole of the battery set and the positive terminal is located at an area between the positive pole of the battery set and the bottom of said push button such that pressing said push button initiates electrical continuity between the battery set and the lighting member, thereby causing the lighting member to emit light.
